(19) United States
(12) Patent Application Publication
(10) Pub. No.: US 2005/0166246 A1
(43) Pub. Date: Jul. 28, 2005

(54) Downloading of software programs

(76) Inventors: Eric Calmels, CAEN (FR); Eric Desmicht, Caen (FR)

Correspondence Address: PHILIPS INTELLECTUAL PROPERTY & STANDARDS, P.O. BOX 3001, BRIARCLIFF MANOR, NY, 10510, US

(21) Appl. No.: 10/508,287

(22) PCT Filed: Mar. 14, 2003
(86) PCT No.: PCT/IB03/01063

(30) Foreign Application Priority Data
Mar. 22, 2002 (FR) 02/03615

(51) Int. Cl. H04N 7/173

(52) U.S. Cl. 725/105

(57) ABSTRACT

The invention relates to a receiver [STB] intended to process at least one content [p] sent by a transmission station over a netowrk [NET] including transportation channels configured for transporting said content, characterized in that it can be connected during so-called supply events on a so-called program channel [PGC] belonging to said network [NET]. The program transportation channel [PGC] conveys according to the invention at least one content [P(SW)] including at least one software programs [SW], intended to control the receiver, coded and in a loop. The receiver [STB] is connected [CNX] to said program channel [PGC], reads and decodes [DEC] and stores said software program [SW] in a volatile memory [VME]. Control means [CNT] controlled by a so-called supply program [SPG] stored in a non-volatile memory [NVM] control the connection [CNX] of the receiver [STB] to the program channel [PGC], the reading and decoding [DEC] and the storing [STR] of the software programs [SW].

The invention relates to a receiver intended to process at least one content sent by a transmission station via a network including transportation channels configured to transport said content. In particular, the invention relates to the transportation and downloading of software programs on said network.

Document U.S. Pat. No. 5,790,753 describes a receiver of this type intended to decode video contents, as well as software programs downloaded from a transmission station. According to this document, the downloading is performed at the request of the receiver, which sends a request message to the transmission station over a bidirectional communication channel between said receiver and said transmission station. This bidirectional channel requires, in addition to its own use by a data transmission means, means of generating requests within the receiver to the network and to the transmission station, means of receiving and processing these requests within the transmission station, means for the selective transmission of the software program or programs to the electronic apparatus by means of which a request was sent, means of checking errors in the software program actually downloaded in the receiver, and means of reiterating the request in the case where the software program downloaded is erroneous. This return channel also makes it possible, in one advantageous implementation, to update a software program on questioning of the transmission station by the receiver. The receiver sends a message over the return channel by questioning the transmission station on the version of the software available, and the transmission station compares the software versions and sends a new version of the software if such is available. The downloading method proposed in the document cited is a method based essentially on sendings of data on request from the receiver to the latter.

The invention relates to the following considerations:

The sum of the means necessary for using the return channel and the downloading on request gives rise to not insignificant costs, in particular when it is wished to have a return channel by cable modem, which constitutes an expensive item of equipment with specific and expensive components (tuner etc). These costs are in particular generated at the receiver intended to process the various contents and having a facility for downloading software programs. Electronic apparatus of this type is therefore particularly expensive. This is prejudicial on some markets in which the consumers assess the advantages afforded by such electronic apparatus as being too small compared with the cost price.

One aim of the invention is to greatly reduce the cost of such electronic apparatus by proposing a receiver with a lightweight and low-cost structure and a transmission station, downloading method and signal compatible with said receiver.

In fact a secure data processing system is characterized according to the invention in that it includes:
connection means for making a connection, when so-called supply events occur, with at least one so-called program transportation channel, the program transportation channel transporting a content including a continuous stream of data coming from said transmission station, said data including at least one software program, intended to control said receiver, coded in a loop, from the transmission station to said receiver,
means of decoding said continuous stream of data in order to decode the software program,
storage means including at least one volatile memory for storing said software program,
means of controlling the connection, decoding and storage means controlled by a so-called supply program stored in a non-volatile memory.

The receiver proposed in combination with a transmission station and a signal transmitted over the program transportation channel both compatible with its functioning makes it possible to avoid the costs relating to the implementation of a return channel and the sending of data on request from the receiver. The saving is achieved both within the receiver itself and within the transmission station. According to the invention, when a so-called supply event occurs, for example a user who connects his receiver, the receiver is connected to the program transportation channel and can thus recover a software program, intended to control it, over a program transportation channel of the network without any other expensive operation. The speed of downloading depends on the bandwidth allocated for the software downloading by the operator. The supply events can for example be the connection of the receiver to the supply mains or the start or end of a standby period, or a signal coming from the transmission station to supply the receiver with a new software program or a new version of a software program. The supply program includes special instructions for making the means of connection, decoding and storage of the data stream function differently on the supply network according to the various events possible.

In an advantageous application of the invention, the receiver is such that at least one content is a content including video and/or audio data, said receiver being intended to be connected to an apparatus for exploiting said data. This exploitation apparatus may for example be a television receiver. This is the case in particular with set-top boxes, decoding/receiving boxes separate from a receiver/final user of the decoded data.

In an advantageous embodiment of the invention, the receiver also includes means for managing conditional access information received amongst the data transmitted by the network to said receiver, said conditional access information acting on said control means in order to enable or not the functioning of the decoding means for at least one content including a software program transported over said program transportation channel. This embodiment is particularly useful when the network continuously and permanently sends several software packages, or even several software versions, over one or more program transportation channels. The various software packages may for example correspond to different functionalities intended to function in a receiver according to the invention in order to control it. These different functionalities may not be essential to a basic functioning of the receiver and may for example be sold as options. The various software versions may, for example, correspond to improvements having additional functionalities to which access may also be obligatory (updating of all the receivers) or optional. In the case of optional software and versions, for example sold at a price higher than a basic version of an item of software, management of accesses according to the advantageous embodiment is useful.

In a preferred embodiment of the invention, the only non-volatile memory present within the receiver is the one which includes the supply program and the downloaded software programs include the application software programs necessary, within the receiver, for the processing of a content sent by the transmission station. This has the effect of making it possible to obtain a receiver which contains the minimum of non-volatile memory, which is expensive. According to the invention, the so-called application software programs essential to the functioning of the receiver are permanently available on said program transportation channel in order to be downloaded and stored in a less expensive volatile memory in order to be used by processing means and within these to allow the processing of at least one content distinct from the one present on the program transportation channel and sent by the transmission channel.

The invention also relates to a signal including digital data, intended to be transported on a so-called program transportation channel from a transmission station to at least one receiver, characterized in that said digital data comprise at least one content including a software program, intended to control said receiver, sent coded and in a loop (e.g. in a repetitive way) by said transmission station. The invention also relates to said transmission station, a downloading method and a “computer program” product used in a receiver according to the invention.

The invention will be further described with reference to examples of embodiments shown in the drawings to which, however, the invention is not restricted.

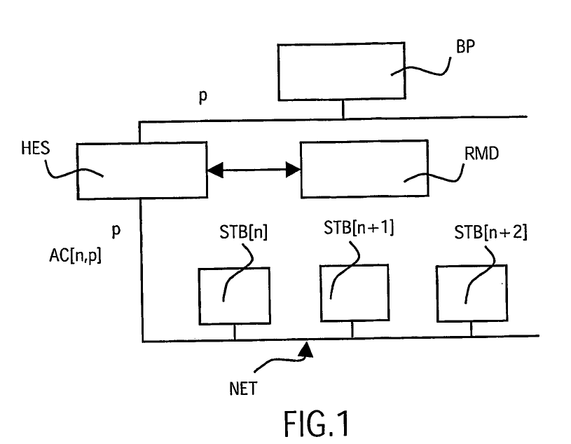

FIG. 1 is a schematic diagram of an example of a network of cabled receiving boxes in which the invention finds an application,

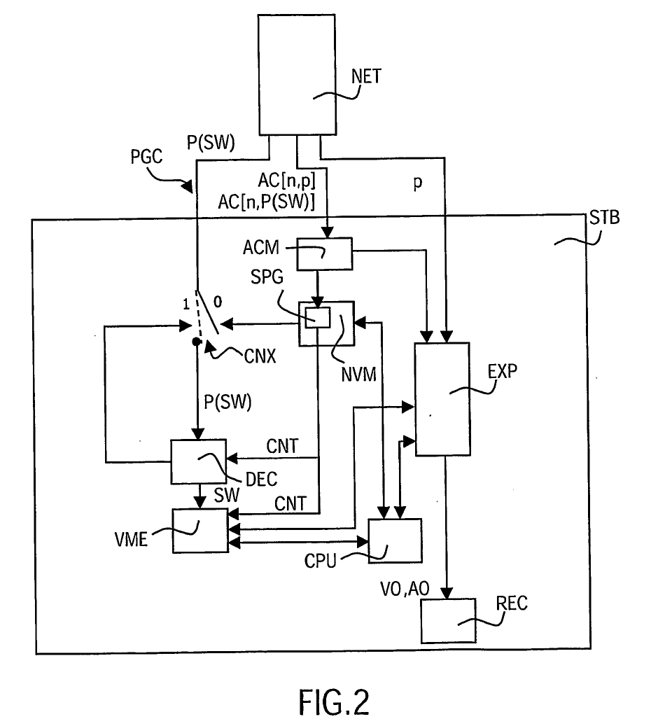

FIG. 2 is a schematic diagram of a receiver according to the invention,

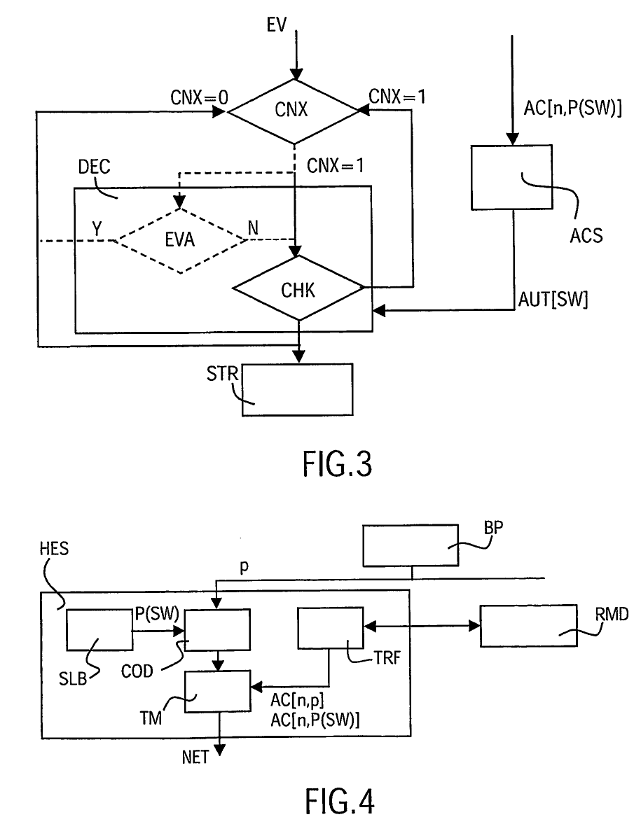

FIG. 3 is a schematic diagram of a method according to the invention,

FIG. 4 is a schematic diagram of a transmission station according to the invention.

The following remarks concern the reference signs. Similar entities are designated by identical letters in all the Figures. Several similar entities may appear in a single Figure. In this case, a digit or a suffix is added to the reference by letters in order to distinguish similar entities. The digit or suffix may be omitted for reasons of convenience. This applies to the description and to the claims.

The following description is presented to enable a person skilled in the art to implement and make use of the invention. This description is provided in the context of the patent application and its requirements. Various alternatives to the preferred embodiment will be obvious to a person skilled in the art and the generic principles of the invention disclosed here can be applied to other uses. Thus the present invention is not deemed to be limited to the embodiment described but rather to have the widest scope in accordance with the principles and characteristics described below.

FIG. 1 is a schematic diagram of an example of a cabled network of receiving boxes or receivers within which the invention can advantageously be applied. It should be noted here that this Figure is only indicative of a special application of the invention where the receiving boxes are cabled. At least one data sender BP offers a content p. The term sender is here used for defining any entity which produces content and/or which makes a content compatible with the distribution: for example, a television studio which produces contents in television program form. The term may refer either to a technical receiver by which the content is sent or to a legal or commercial entity associated with the content. The term content p is here used for defining data which can be used in practice within a receiver: this will for example be audio and/or video data (a television program for example), interactive data, computer software programs, data associated with particular software programs or other types of data. This sender BP is connected to a transmission station HES which makes it possible to send data in a certain transportation format over a network consisting of transportation means NET. In the digital television applications which particularly relate to the invention, the transportation format is for example in accordance with the MPEG standard. Any other standard used in digital television or in transportation of digital data can be used according to the invention. According to FIG. 1, this transmission station is for example the head transmission station of a cable television network and the transmission means NET consist of a cable. This is only one example, and the transmission station and the transportation means NET may be various: radio network, telephone connection, network connection (Internet for example), a satellite, in which case the transmission station HES is a network operation center of a satellite transmission system etc. Other senders of contents can be connected to this transmission station HES in the same way as the sender BP. The transmission station HES has in particular a role of multiplexing the various contents P and of adding supplementary conditional access information AC[n,p] in the data stream according to the authorizations for access to the various contents sent by said transmission station granted to one or more receiving boxes STB[n] to which a content p can be sent. This addition of supplementary information is carried out by means of a database intended for managing rights of the users RMD. This addition is periodic, the periods of insertion of this information being variable. Thus this supplementary information AC[n,p] serves for the conditional management of accesses. It is for example messages according to the EMM (“Entitlement Management Messages”) and ECM (“Entitlement Control Messages”) standards or any other message using an identifier for the receiving boxes STB. The transmission station also in general has a role of scrambling certain particular contents. For simplification, the scrambling effected in general on, for example, the video and/or audio contents is not presented. This is because this scrambling functions in parallel to the invention without interacting with it. Only the coding of certain particular contents according to the invention will be discussed more fully. According to FIG. 1, various user receiving boxes STB are connected by transportation means NET to the transmission station HES. Whatever the transportation means (cable etc), the principles of connection between the receiving boxes STB and the transmission station HES are similar and known from the state of the art. A connection according to the state of the art can therefore be used for implementing the invention. The use of the transportation means will however be different according to the characteristics described below and peculiar to the invention. The data stream is transmitted to the various receiving boxes STB by said transportation means NET. Said receiving boxes STB conventionally include memories where software programs are stored for permitting the management of the processing of the contents. Such software programs are referred to as application software programs hereinafter. These software programs refer to all kinds of software programs which can advantageously be used in a receiving box STB for controlling the processing of data included in the content or contents according to certain functionalities which the receiver may have occasion to implement: decoding etc.

FIG. 2 is a schematic diagram of a receiving/decoding box according to the invention. The various elements of the receiving box or receiver will now be described in terms of functional units. The receiving/decoding box, which can advantageously be a digital receiving box for digital television, known in general as a “set-top box”, includes a central processor CPU connected to non-volatile memory elements NVM, and volatile memory elements VME and means EXP of processing contents received. The non-volatile memories may be FLASH memories, ROM memories, or EEPROM memories, and the volatile memories are generally RAM memories. These memories contain data and programs for making the CPU function according to the functionalities of the receiver, and in particular they may include application programs. The central processor CPU is also generally adapted for receiving data from interfaces I, which may be serial interfaces, parallel interfaces, a modem, control elements placed on an external face of the receiving box and on a remote control connected to a control unit, readers for various media etc. A receiving box according to the invention can in particular comprise one or more smart card readers which make it possible to add functionalities and/or flexible and modular conditional access controls (payment per session for example). The means of processing received contents EXP include in general means for selecting the contents (tuner), means of demodulating the stream of data transmitted by the transportation means and means for the data stream to be filtered, demultiplexed and decoded within said processing means. These processing means use in particular many kinds of software programs for fulfilling in particular the functions of filtering, decoding, unscrambling, demultiplexing etc disclosed above. Any software program making it possible to perform the content processing operations disclosed above is referred to as an application software program. According to the invention, these processing means can therefore be controlled or even implemented by at least one such application software program stored in the volatile memory VME during the functioning of a method according to the invention. For example, a receiver/decoder according to the invention includes application software programs downloaded and stored in memory, for processing and using the contents p distinct from the content or contents including said software programs, so as to convert them, for example, into video output data VO and/or audio output data AO which can be used for example in an apparatus for exploiting the data REC. This exploitation apparatus will for example be a television set. The structures themselves of the application software programs are not described here since they are known from the state of the art. The software programs downloaded and stored according to the invention are in fact equivalent to those stored in general in non-volatile memories in receivers/decoders. In the conventional receiving boxes of the state of the art, the application programs not being made available to the receiver continuously on an accessible channel, it is necessary for the boxes themselves to contain the major part of the application programs in a non-volatile memory in order not to lose them each time they are disconnected for example. This involves having a large non-volatile memory which increases when the number of functionalities of the receiver increases, and this kind of memory is expensive.

According to FIG. 2, a receiving box is a receiver STB according to the invention when it includes connection means CNX for, when so-called supply events occur, connecting said receiver STB to at least one so-called program transportation channel PGC. Said channel PGC constitutes transportation means belonging to said network NET. The so-called transportation channel is typically the equivalent of a television channel in one advantageous embodiment. The frequency of this channel (or the frequency of the channels which will serve as program channels in the event of a plurality of program channels) are for example loaded in the non-volatile memory NVM during phases of producing and configuring the receiver STB, by means of an EJTAG or RS232 generic serial interface. The program transportation channel PGC conveys at least one continuous data stream P(SW), which is a content coded in said format including a software program SW coded repetitively in a loop from the transmission station to the receiver STB. The data stream P(SW) is transported according to the transportation format on said program transportation channel PGC. According to the invention, the receiver includes connection means CNX depicted in the schematic form of a switch with positions 0 and 1 connected to said program transportation channel PGC, decoding means DEC and storage means VME which are controlled by control means CNT controlled by a so-called supply program SPG stored in a non-volatile memory NVM. When the connection is established, that is to say, here, when the connection means CNX are switched to position 1, under the control of control means CNT controlled by the so-called supply program SPG, the receiver STB according to the invention reads the continuous data stream P(SW) on the so-called program channel PGC. The reading can be carried out either on a single channel or on several channels at the same time or following each other. If the reading is carried out on several channels, the same number of connection means can be used for implementing the invention. The decoding means will then be configured for effecting a decoding of the data present on the channels read. In order to simplify the description of the invention, FIG. 2 is presented with a single channel. The decoding means DEC of the said continuous stream of data P(SW) decode the software program SW. As the software program or programs transported on said program transportation channel are sent in a loop, the decoding means manage, whatever the time when the connection means are switched to position 1, to read all of said software program or programs. The receiver STB according to the invention includes storage means in the form of at least one volatile memory VME for then storing said software program SW.

In one advantageous embodiment of the invention, the receiver according to the invention includes conditional access means ACM intended to function in collaboration with conditional access codes AC[n,p] sent over the network by the transmission station. These codes AC[n,p] sent by the transmission station in the data stream over the network are intended to enable decoding in a given receiver n of a content p, which may in particular be a data stream P(SW) including a software program. Means known from the state of the art are here advantageously used (standard DVB, standing for “Digital Video Broadcasting”, EMM, standing for “Entitlement Management Messages” and ECM, standing for “Entitlement Control Messages”, mechanisms, for example). Any other conditional access management mechanism can however be used. These conditional access means enable or not, by means of control means CNT, the functioning of the decoding means DEC for decoding a content P(SW) including a given software program SW, read on the program channel by the receiver STB bearing the number n.

In a preferred embodiment of the invention, the receiver includes only one non-volatile memory NVM present in the receiver STB. This single non-volatile memory NVM includes the supply program to the exclusion of the application software programs. The software programs SW downloaded and stored in volatile memory include, according to this embodiment, all the application software programs necessary, in the receiver STB, for the processing of the data of the contents received by the receiver STB in said format. The volatile memory is an element always present in the state of the art in a receiver intended for processing at least one content sent in a transportation format by a transmission station. This volatile memory serves at least for the execution of the various codes necessary for the functioning of the receiver. The additional cost of implementing this memory in a receiver according to the invention is therefore zero, which makes the final receiver very inexpensive and particularly advantageous since it possesses the same functions as a more expensive receiver, by virtue of the downloaded application programs. In addition a receiver according to the invention can easily be modified by the transmission station according to the intention of the manager of all the receivers and/or according to the intention of the user, who can pay to have additional functions added, an addition facilitated by the invention.

FIG. 3 is a schematic diagram of a method according to the invention, a method explaining the functioning of the various means present in a receiver according to the invention and described above. This method is implemented by software and/or hardware means implemented on a non-volatile memory NVM (for example a ROM memory). These software and/or hardware means constitute a supply program intended to prompt the various means according to the invention to function in a certain way which will be described by the method according to the invention following the advent of an event EV and according to said event EV. The implementation according to the invention of said supply program on a non-volatile memory NVM has the advantage that this supply program can be activated permanently in the non-volatile memory NVM in the receiver according to the invention and that by itself the supply program will be capable of allowing the downloading of application programs necessary for controlling the receiver. These application programs downloaded and then stored in volatile memory are in fact lost whenever the volatile memories are erased, for example by a loss of power.

There are many ways of implementing the functional entities presented in the steps of a method according to the invention by software and/or hardware means accessible to a person skilled in the art. This is why FIG. 3 is schematic. Thus, although the Figures show various functional entities implemented by various units, this does not exclude several functional entities being present in a single software and/or hardware means. Nor does this exclude a combination of software and/or hardware means making it possible to produce a functional entity.

According to the method of the invention, an event EV triggers the start of a method generated by the so-called supply program, depicted overall in FIG. 3. The supply events EV may for example be the connection of the receiver to the mains or the start or end of a standby period, or a signal coming from the transmission station for supplying the receiver with a new software program or possibly a new version of a software program for replacing a software program previously stored in memory in the receiver but superceded. Whatever the type of event EV occurring, a connection step CNX triggering the connection means of the receiver is controlled by the supply program and the switch is then switched to position 1 if it was not already there. Once the connection means CNX are in position 1, the receiver can read the continuous data stream transported over at least one so-called program channel PGC. Next a decoding step DEC is performed on the coded data stream read by the decoding means. The authorization to perform the decoding step DEC can be granted according to a conditional access management step ACS implemented as described in the description of FIG. 2. A conditional access management step ACS is therefore advantageously performed by means of the reception of conditional access information AC[n,P(SW)], said management step ACS giving or not authorization AUT[SW] at the decoding step DEC for the content P(SW). A substep CHK of checking the downloading is implemented in the decoding step DEC. This checking step advantageously checks whether there is an error in the downloaded program and checks whether the downloaded program is complete. Means of checking the data stream according to the state of the art can be implemented here (checking of signatures, use of a data packet with a head element according to various standards, for example MPEG etc). If the downloaded software program is indeed downloaded and/or is complete, a command is sent by the so-called supply program to the connection means CNX in order to change them to position 0, if the data including the downloaded software program include errors and/or do not constitute the complete software program, a command CNX=1 makes it possible to keep the connection means in position 1 until the software program is downloaded correctly and fully. A step STR of storing the software program in a volatile memory of the receiver is then performed. The downloaded software program can thus be used in the content processing means EXP in the manner disclosed above.

The decoding step can advantageously include a substep EVA of evaluating the version of the program transported by the data stream and comparing at least one version of a software program already stored in the receiver. As the software program or programs transported on said program transportation channel are sent in a loop, the decoding means manage, whatever the time when the connection means are switched to position 1, to evaluate which is the version present for a said program on the program transportation channel. If the version on the program transportation channel is the same as a version already stored (case Y), a command CNX=0 is sent to the connection means in order to switch them to position 0. If the version is different or the corresponding program absent (case N), the data stream is sent in a decoding step DEC similar to that described above. The program is then stored in a volatile memory in a storage step STR similar to that described previously. This avoids the software programs already stored being downloaded once again. This could in particular be the case when the supply event is a signal coming from the transmission station for supplying the receiver with a new software program or possibly a new version of a software program for replacing a software program previously stored in memory in the receiver but superceded. This signal is for example a message from the transmission station informing it for example that a new version of a given software program is available and should be loaded onto the receiver or that a specific application program for which the user has paid is available on a program transportation channel and must be loaded by the receiver. Such an indication may be made periodically, for example each hour. Such messages sent over the network force the receiver to download the corresponding programs. However, if the receiver has already received such a message and has already downloaded the version or the software program, it is useful to carry out a test on the nature of the version or the presence of the program to be downloaded. An order of magnitude of the duration of downloading of the programs essential to the basic functioning of a receiver/decoder (set-top box) on a conventional digital data transportation channel is around one second, which makes the invention highly advantageous.

FIG. 4 is a schematic diagram of a transmission station BES according to the invention. As seen previously, said station HES is implemented in relation to a program transmitter BP. The transmission station is also generally connected to a database RMD in which there are listed the access rights of the various items of electronic receivers receiving contents p coming from the transmission station HES. These access rights take the form of an access code AC[n,p] peculiar to the content p and to the receiver n connected to the network NET connected to the transmission station HES. The access rights read in the database RMD are converted into access codes AC[n,p] in a conversion module TRF. According to the invention, the downloaded software programs SW can either be stored in a database SLB in said transmission station HES, or be received in the form of content p coming from a transmitter BP. In all cases, these software programs are sent to coding means COD which code in particular the programs SW as a data stream P(SW), and then in transmission means TM which transmit the various coded data to the transportation means NET and in particular the data stream P(SW) to the program transportation channel of the network NET. The transmission means TM also advantageously receive the access codes AC[n,p], some contents p of which are, according to one advantageous embodiment of the invention, such that p=P(SW). A conditional access to said program transported on the program transportation channel for the receiver is therefore implemented by virtue of such access codes in this advantageous embodiment. All these elements implementing a conditional access control to the programs constitute a software management system by means of which the transmission station can re-update and manage the distribution of software programs on a stock of receivers. This is because such a system manages the various software programs associated with the various items of electronic receiver according to the invention. For example, an access code for the data stream P(SW) is inserted for each of the receiving boxes whose owner has paid to receive said software program SW. The content of these access codes may be variable over time, in particular the various items of information contained in a code can be sent at different periodicities. This access code is compatible with the known receiving box identification systems (identifying number of the receiver for example) and/or advantageously uses the existing standards (DVB, standing for “Digital Video Broadcasting”, EMM, standing for “Entitlement Management Messages” and ECM, standing for “Entitlement Control Messages” mechanisms for example). For example, the book “Digital Television and MPEG-1, MPEG-2, European DVB System” by Hervé Benoit, published by DUNOD, describes these identification systems. In particular, the Simulcrypt DVB standard described in particular in the above-mentioned book makes it possible to transport the content p only once and scrambled in only one way for all the receiving boxes connected, and hence an appreciable saving in bandwidth. A management of this type is peculiar to the invention since, when the downloading is carried out at the request of the receiver, such management is unnecessary. As the program sent in a loop over the program transportation channel must be available continuously for all the receivers having authorization, it is necessary to send access codes with a frequency which is advantageously higher than that normally used for conventional contents: audio and/or video for example. A period of a maximum of 10 seconds is desirable for the user. This is possible with fairly small access codes in order to take up the bandwidth to the minimum extent. These access codes will be numerous but they do not need to give rise to as high a level of security as for the broadcasting of contents which can be directly used, such as audio/video contents. They will consequently be lighter than those used in order for example to protect the contents of a video program. Another principle of use of the access code is possible in a smart card system. This possibility is similar to that used for pay per view. The smart card contains a rewritable non-volatile memory of modest size (a few kilobits) compared with the size of the software program to be recovered (2 Mbytes or even more). This memory can be used for storing the “preauthorization” data, said data being sent at a low frequency (for example every month according to the conventional subscription period). As soon as the box is powered up, the program is recovered immediately by virtue of these “preauthorization” means stored for the given period. Such a principle can also be implemented in a receiver which does not have a smart card reader with a small non-volatile memory making it possible to store a few access codes AC[n,P(SW)]. The principle of “preauthorization” granted for example for one month is the same.

Although this invention has been described in accordance with the embodiments presented, a person skilled in the art will immediately recognize that there exist variants to the embodiments presented and that these variants remain within the spirit and within the scope of the present invention. In particular, conventional multiplexing elements on said program transportation channel are advantageously used for sending several programs over the same program transportation channel without this changing the principle according to the invention. Thus many modifications can be made by a person skilled in the art without for all that being excluded from the spirit and scope defined by the following claims.

1. A receiver intended to process at least one content sent by a transmission station via a network including transportation channels configured for transporting said content, characterized in that it includes:
connection means for making a connection, when so-called supply events occur, with at least one so-called program transportation channel, the program transportation channel transporting a content including a continuous stream of data coming from said transmission station, said data including at least one software program, intended to control said receiver, coded in a loop, from the transmission station to said receiver,
means of decoding said continuous stream of data in order to decode the software program,
storage means including at least one volatile memory for storing said software program,
means of controlling the connection, decoding and storage means controlled by a so-called supply program stored in a non-volatile memory.

2. A receiver as claimed in claim 1, characterized in that at least one content is a content including video and/or audio data, said receiver being intended to be connected with an apparatus for exploiting said data.

3. A receiver as claimed in one of claims 1 and 2, characterized in that it also includes means for managing conditional access information received amongst the data transmitted by the network to said receiver, said conditional access information acting on said control means in order to enable or not the functioning of the decoding means for at least one content including a software program transported on said program transportation channel.

4. A receiver as claimed in any one of claims 1 to 3, characterized in that the only non-volatile memory present in the receiver is the one which includes the supply program and in that the software programs downloaded include the application software programs necessary, in the receiver, for the processing of a content sent by the transmission station.

5. A station for sending at least one content to at least one receiver intended to process said content, said transmission station using a network including transportation channels configured for transporting said content, characterized in that it includes:
means of coding a content including a software program intended to control said receiver,
means of transmitting said coded software program in a loop to a so-called program transportation channel like a continuous stream of data.

6. A transmission station as claimed in claim 5, characterized in that it also includes a software program manager for managing access of at least one receiver to at least one content including a software program, said manager inserting, in the data transmitted by the network to said receiver, conditional access information, said conditional access information acting on control means in said receiver enabling or not the decoding of the content including said software program.

7. A method for downloading software programs from a station for sending at least one content to at least one receiver intended to process said content via a network including transportation channels configured for transporting said content, characterized in that it includes the steps of:
connection of said receiver, when so-called supply events occur, with at least one so-called program transportation channel, said program channel transporting a content including a continuous stream of data coming from said transmission station, said data stream including at least one software program, intended to control said receiver, coded in a loop,
decoding of said continuous data stream in order to decode the software program,
storage in at least one volatile memory for storing said software program,
said connection, decoding and storage steps being controlled by control means controlled by a so-called supply program stored in a non-volatile memory of said receiver.

8. A method as claimed in claim 7, characterized in that it includes a step of managing conditional access information received amongst the data transmitted by the network to said receiver, said management step making it possible to act on the control means in order to enable or not the decoding step for at least one content including a software program transported on said program transportation channel.

9. A “computer program” product, characterized in that said “computer program” product comprises a set of instructions which, when it is loaded in a receiver intended to process at least one content sent by a transmission station over a network including transportation channels configured for transporting said data as claimed in one of claims 1 to 4, causes the receiver to perform one or more steps of the method claimed in one of claims 7 and 8.

10. A signal including digital data, intended to be transported on a so-called program transportation channel from a transmission station to at least one receiver, characterized in that said digital data comprise at least one content including a software program, intended to control said apparatus, sent coded and in a loop by said transmission station.
